(19) United States
(12) Patent Application Publication
(10) Pub. No.: US 2025/0037550 A1
(43) Pub. Date: Jan. 30, 2025

(54) METHOD AND ELECTRONIC DEVICE FOR PROVIDING ENVIRONMENTAL AUDIO ALERT ON PERSONAL AUDIO DEVICE

(71) Applicant: Samsung Electronics Co., Ltd., Suwon-si (KR)

(72) Inventor: Chirag GARG, Noida (IN)

(21) Appl. No.: 18/643,663

(22) Filed: Apr. 23, 2024

Related U.S. Application Data
(63) Continuation of application No. PCT/KR2024/004727, filed on Apr. 9, 2024.

(30) Foreign Application Priority Data
Jul. 24, 2023 (IN) 202311049818

(51) Int. Cl. G08B 3/10; H04S 7/00

(52) U.S. Cl. CPC G08B 3/1008; H04S 7/303; H04S 2400/11; H04S 2420/01

(57) ABSTRACT

The disclosure relates to a method for providing an environmental audio alert on a personal audio device. The method includes: determining head direction of a user in an environment in a time frame. The method includes detecting an audio event occurring in the environment in the time frame. The method includes determining direction of a source of the detected audio event. The method includes localizing a sound source with respect to the determined head direction of the user for generating a spatial binaural audio alert and providing the generated spatial binaural audio alert on the personal audio device.

### CROSS-REFERENCE TO RELATED APPLICATIONS

This application is a continuation of International Application No. PCT/KR2024/004727 designating the United States, filed on Apr. 9, 2024, in the Korean Intellectual Property Receiving Office and claiming priority to Indian patent application No. 202311049818, filed on Jul. 24, 2023, in the Indian Patent Office, the disclosures of each of which are incorporated by reference herein in their entireties.

### BACKGROUND

### Field

The disclosure relates to personal audio devices and, for example, to a method and an electronic device for providing an environmental audio alert on the personal audio device.

### Description of Related Art

Personal audio devices are electronic devices that are designed to play audio content for personal listening. In recent years, the personal audio devices have become increasingly popular among people of all ages, from children to adults as they offer a convenient and affordable way to enjoy the audio content. However, these personal audio devices limit abilities of the users to hear what is happening in their surroundings due to noise-cancelling effects, which effectively block the outside world, including important sounds such as approaching traffic or emergency alerts, and hence make the users more vulnerable to accidents or dangers when they are performing some activity such as walking, cycling, or driving.

Therefore, it is important to provide the personal audio devices that enable the users to enjoy the audio content and also make them aware of their surroundings whenever needed.

There is art that discloses about spatial audio on personal audio device.

The existing art discloses a spatial audio to enable safe headphone use during exercise and commuting. The art further discloses about producing sound through headphones in a manner that improves user experience and increases safety. In some circumstances, such as when the user is moving during exercise or commuting, etc., an audio safety spatialization mode of the headphones is automatically activated. In this mode, sound is spatialized such that when the user turns his head, the sound appears to be generated from a same position in space as before the user turned his head. If the user's head remains in the turned position, the spatialized sound will return to an initialized position with respect to the user's head. However, the existing art does not disclose about determining direction of environmental audio event producing source. Further, there is no mention of localization of personalized virtual sound source based on the user parameter such as HRTF, pinna, interaural time and level difference values. In addition, the prior art is silent about generating a binaural alert on the basis of current head direction and direction of the audio event producing source and providing the alert on the personal audio device.

Further, the art discloses a coordinated tracking for binaural audio rendering. The art further discloses a binaural sound reproduction system, and methods of using the binaural sound reproduction system to dynamically re-center a frame of reference for a virtual sound source, are described. The binaural sound reproduction system may include a reference device, e.g., a mobile device, having a reference sensor to provide reference orientation data corresponding to a direction of the reference device, and a head-mounted device, e.g., headphones, having a device sensor to provide device orientation data corresponding to a direction of the head-mounted device. The system may use the reference orientation data to determine whether the head-mounted device is being used in a static or dynamic use case, and may adjust an audio output to render the virtual sound source in an adjusted source direction based on the determined use case. Various embodiments are also described and claimed. However, the existing art does not disclose about determining direction of environmental audio event producing source. Further, there is no mention of localization of personalized virtual sound source based on the user parameter such as HRTF, pinna, interaural time and level difference values. In addition, the prior art is silent about generating a binaural alert on the basis of current head direction and direction of the audio event producing source and providing the alert on the personal audio device.

Therefore, in light of the foregoing, there exists a need to address the aforementioned drawbacks associated with the existing system and method for providing spatial binaural environmental audio alert on a personal audio device.

### SUMMARY

According to an example embodiment, a method for providing an environmental audio alert on a personal audio device is provided. The method may comprise determining head direction of a user in an environment in a time frame. The method may comprise detecting an audio event occurring in the environment in the time frame. The method may comprise determining a direction of a source of the detected audio event. The method may comprise localizing a sound source with respect to the determined head direction of the user for generating a spatial binaural audio alert and providing the generated spatial binaural audio alert on the personal audio device.

According to an example embodiment, an electronic device for providing an environmental audio alert on a personal audio device may be provided. The electronic device may comprise a memory storing instructions; and at least one processor configured to, when executing the instructions, cause the electronic device to perform operations. The operations may comprise determining head direction of a user in an environment in a time frame. The operations may comprise detecting an audio event occurring in the environment in the time frame. The operations may comprise determining a direction of a source of the detected audio event. The operations may comprise localizing a sound source with respect to the determined head direction of the user for generating a spatial binaural audio alert and providing the generated spatial binaural audio alert on the personal audio device.

According to an example embodiment, a non-transitory computer readable storage medium storing instructions is provided. The instructions which, when executed by at least one processor of an electronic device, cause the electronic device to perform operations. The operations may comprise determining head direction of a user in an environment in a time frame. The operations may comprise detecting an audio event occurring in the environment in the time frame. The operations may comprise determining a direction of a source of the detected audio event. The operations may comprise localizing a sound source with respect to the determined head direction of the user for generating a spatial binaural audio alert and providing the generated spatial binaural audio alert on the personal audio device.

According to an example embodiment, a method for providing spatial binaural environmental audio alert on a personal audio device is provided. The method comprises: determining head direction and activity of a user in an environment in a time frame, wherein, the head direction and the activity is determined using a processing module while the user is on a call or listening to music using the personal audio device, which includes, but not limited to, around-the-ear, over-the-ear and in-ear headsets, headphones, earphones, earbuds, hearing aids, audio eyeglasses, head-worn audio devices, shoulder- or body-worn acoustic devices, or other similar personal audio devices, during the activity, such as, but not limited to, sitting, walking, jogging, running, or any other movement. The head direction and the activity of the user in the time frame is determined by operations comprising: determining the head direction and the activity of the user by an inertial measurement unit using sensor data collected from a plurality of sensors. In an example embodiment, the head direction and the activity is determined by performing functions comprising: receiving sensor data from a reference point that works as a reference for sensor data, wherein the sensor data is received from a sensor block which includes the plurality of sensors such as, but not limited to, a three-axis accelerometer, a three-axis gyroscope, and a three-axis magnetometer. The functions further comprising: calibrating the sensor data by monitoring difference between input and output sensor data of each sensor and adjusting the output sensor data to align with the input and filtering and smoothing the calibrated sensor data to provide an accurate head direction and the activity of the user.

According to an example embodiment operations of determining the head direction and the activity of the user in the time frame further comprises: determining time frame by a time frame detection unit based on initial time frame or computation time of each module including maximum interaural time delay (ITD), time taken by the audio classification module, time taken by the audio direction determination module, and time taken by the binaural alert generator.

According to an example embodiment, the method further comprises capturing one or more audio events occurring in the environment in the time frame. In an example embodiment, the audio event is captured and is classified by an audio classification module by performing operations including receiving the head direction and the activity of the user from the processing module and capturing one or more audio events occurring in the environment. The operations further comprise determining maximum interaural time differences (ITD) and maximum interaural level differences (ILD) by a maximum interaural time and intensity detection unit for the user for the captured one or more audio events in the time frame to derive maximum angle deviation from the received head direction and the activity. In an example embodiment, the maximum ITD may be determined based on maximum of maximum ITD from previous time frames and ITD from each of the one or more audio events occurred in the environment and maximum ILD is determined based on maximum level of the one or more audio events;
According to an example embodiment, the method further comprises: generating frequency spectrum of head related transfer function (HRTF) by a frequency spectrum generator for each audio event captured in the time frame based on the head direction of the user and extracting audio spectral features of the one or more audio events captured in the time frame. According to an example embodiment, audio spectral features are extracted by an audio spectral features extracting sub-module which includes a discrete fourier transform, a Mel filter bank, and a MFCC. The operations further comprise: classifying each audio event as noise or significant audio by a classification sub-module using a convolution neural network on the extracted audio spectral features from the audio spectral features extracting sub-module, historical audio spectral features from spectral features database, and maximum ITD and maximum ILD from the maximum interaural time and intensity detection sub-module. According to an example embodiment, each audio event is classified based on the environment and significance level of the audio and in presence of more than one significant audio, priority is given to the significant audio based on the direction of the audio with respect to the head direction of the user.

According to an example embodiment, the method further comprises determining direction of environmental audio event producing source. According to an example embodiment, the direction of the environmental audio event producing source is determined by an audio direction determination module by performing functions which comprises receiving frequency spectrum of the HRTF for the one or more audio events by a generating sub-module from the audio classification module, generating horizontal plane directivity (HPD), head related impulse response (HRIR) and pinna related transfer function (PRTF) by the generating sub-module from the received HRTF frequency spectrum, computing interaural time difference (ITD) and interaural level difference (ILD) for left and right ears of the user using the HRIR by a computation sub-module, and determining direction of the environmental audio event producing source by a direction estimation sub-module based on the significant audio received from the audio classification module, the ITD and the ILD, the horizontal plane directivity, and spectral cues from the PRTF.

According to an example embodiment, the method further comprises localizing a virtual sound source by a binaural alert generator for generating a spatial binaural audio alert with respect to current head direction of the user and providing the alert on the personal audio device.

According to an example embodiment, the spatial binaural audio alert is generated in operations comprising: receiving direction of the environmental audio event producing source by an audio calibration sub-module from the audio direction determination module, receiving current head direction of the user from the processing module and determining if the received current head direction is different than the head direction determined in the time frame and localizing a virtual sound source for regenerating direction of the environmental audio event producing source with respect to the current head direction of the user by the audio calibration sub-module. The operations further comprise: regenerating interaural time difference (ITD) and interaural level difference (ILD) for the regenerated direction and the head related transfer function (HRTF) interpolation by a regeneration sub-module. The operations further comprise: determining a frequency of audio playing in the personal audio device by a frequency determination sub-module and generating spatial binaural audio alert of frequency based on the frequency of the audio and the HRTF, and adding delay in the spatial binaural audio alert by a delay adding sub-module based on the regenerated ITD and providing on the personal audio device.

According to an example embodiment, the present disclosure provides a system for providing spatial binaural environmental audio alert on a personal audio device. The system comprises: a processing module comprising at least one processor, comprising processing circuitry, individually and/or collectively, configured to: determine head direction and activity of a user in an environment in a time frame; an audio classification module comprising circuitry configured to capture one or more audio events occurring in the environment in the time frame; an audio direction determination module comprising circuitry configured to determine a direction of environmental audio event producing source; and a binaural alert generator comprising circuitry configured to localize a virtual sound source for generating a spatial binaural audio alert with respect to current head direction of the user and providing the alert on the personal audio device.

According to an example embodiment, the alert may include a gamma binaural audio alert or the alert may include a multimodal alert in case the user is equipped with a wearable device which includes, at least but not limited to, a wristband, wristwatch, augmented reality glasses, smart glasses, ring, necklace, or any other electronic device that is worn as an accessory, implanted in the user's body, embedded in clothing, or tattooed on the skin and provided to the user via two dimensional or three dimensional simulations.

The foregoing summary is illustrative only and is not intended to be in any way limiting. In addition to the illustrative aspects, embodiments, and features described earlier, further aspects, embodiments, and features will become apparent by reference to the drawings and the following detailed description.

### BRIEF DESCRIPTION OF THE DRAWINGS

The accompanying drawings, which are incorporated herein and are a part of this disclosure, illustrate various example embodiments, and together with the description, explain the disclosed principles. The same reference numbers are used throughout the figures to reference like features and components. Further, the above and other aspects, features and advantages of certain embodiments will be more apparent from the following detailed description, taken in conjunction with the accompanying drawings, in which:

FIG. 1 is a flowchart illustrating an example method for providing spatial binaural environmental audio alert on a personal audio device, according to various embodiments;

FIG. 2 is a block diagram illustrating an example configuration of the system performing a method for providing spatial binaural environmental audio alert on a personal audio device, according to various embodiments;

FIG. 3 is a block diagram illustrating an example configuration of a processing module, according to various embodiments;

FIG. 4 is a block diagram illustrating an example configuration of an inertial measurement unit, according to various embodiments;

FIG. 5 is a flowchart illustrating an example method of working of the inertial measurement unit, according to various embodiments;

FIG. 6 is a diagram illustrating an example interaural time delay, according to various embodiments;

FIG. 7 is a flowchart illustrating an example method of working of the processing module, according to various embodiments;

FIG. 8 is a block diagram illustrating an example configuration of an audio classification module, according to various embodiments;

FIG. 9 is a flowchart illustrating an example method of working of the audio classification module, according to various embodiments;

FIG. 10A is a block diagram illustrating an example configuration of an audio direction determination module, according to various embodiments;

FIG. 10B is a diagram including graphs illustrating an example direction estimation sub-module, according to various embodiments;

FIG. 11 is a flowchart illustrating an example method of working of the audio direction determination module, according to various embodiments;

FIG. 12A is a block diagram illustrating an example configuration of a binaural alert generator, according to various embodiments;

FIG. 12B is a diagram illustrating an example direction of the environmental audio event producing source with respect to the current head direction of the user, according to various embodiments;

FIG. 12C is a diagram illustrating an example of regenerating interaural time difference for the regenerated direction, according to various embodiments;

FIG. 13 is a flowchart illustrating an example method of working of the binaural alert generator, according to various embodiments;

FIG. 14A is a diagram illustrating a first use case of providing spatial binaural environmental audio alert on the personal audio device, according to various embodiments; and

FIG. 14B is a diagram illustrating a second use case of providing spatial binaural environmental audio alert on the personal audio device, according to various embodiments.

### DETAILED DESCRIPTION

In the following description, numerous specific details are set forth in order to provide a thorough understanding of the present disclosure. It will be apparent, however, to one skilled in the art that these specific details are merely examples and are not intended to be limiting. Additionally, it may be noted that the systems and/or methods are shown in block diagram form to avoid obscuring the present disclosure. It is to be understood that various omissions and substitutions of equivalents may be made as circumstances may suggest or render expedient to cover various applications or implementations without departing from the spirit or the scope of the present disclosure. Further, it is to be understood that the phraseology and terminology employed herein are for the purpose of clarity of the description and should not be regarded as limiting.

Furthermore, in the present disclosure, references to “one embodiment” or “an embodiment” may refer, for example, to a particular feature, structure, or characteristic described in connection with an embodiment being included in at least one embodiment of the present disclosure. The appearance of the phrase “in one embodiment” in various places in the disclosure is not necessarily referring to the same embodiment, nor are separate or alternative embodiments mutually exclusive of other embodiments. Further, the terms “a” and “an” used herein do not denote a limitation of quantity, but rather denote the presence of at least one of the referenced items. Moreover, various features are described which may be exhibited by various embodiments and not by others. Similarly, various requirements are described, which may be requirements for various embodiments but not for all embodiments.

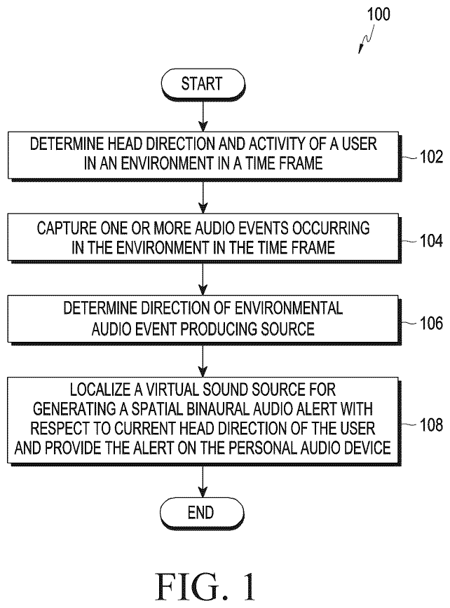

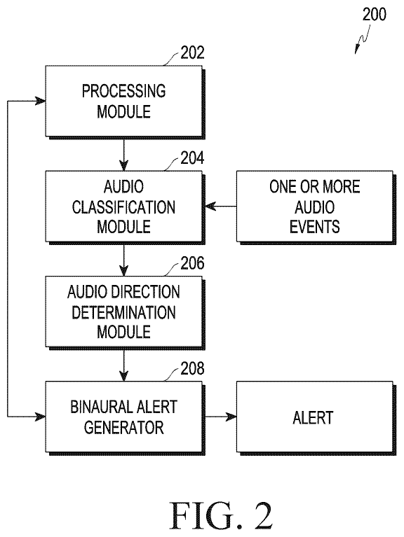

FIG. 1, is a flowchart illustrating an example method (100) for providing spatial binaural environmental audio alert on a personal audio device according to various embodiments. The spatial binaural environmental audio refers to a technology that captures audio from an environment and simulates spatial cues based on anatomy of the head, ear and torso for the two ears to create an immersive and realistic audio experience for the user. This technology is further enhanced by the addition of a spatial binaural environmental audio alert feature. This feature allows users to listen to audio content on their personal devices while also being alerted to their surroundings to enhance safety. The method of providing these spatial binaural environmental audio alerts on personal audio devices may create a safer and more immersive audio experience for users. The method may be explained in conjunction with the system disclosed in FIG. 2. In the flowchart, each block may represent a module, segment, or portion of code, which comprises one or more executable instructions for implementing the specified logical function(s). It should also be noted that in various implementations, the functions noted in the blocks may occur out of the order noted in the drawings. For example, two blocks shown in succession in FIG. 1 may be executed substantially concurrently or the blocks may sometimes be executed in the reverse order, depending upon the functionality involved. Any process descriptions or blocks in flowcharts should be understood as representing modules, segments, or portions of code that include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

At step 102, head direction and activity of a user is determined in an environment in a time frame. In an embodiment, head direction and the activity is determined while the user is on a call or listening to audio or music using the personal audio device. In an example embodiment, the personal audio device includes, but not limited to, around-the-ear, over-the-ear and in-ear headsets, headphones, earphones, earbuds, hearing aids, audio eyeglasses, head-worn audio devices, shoulder- or body-worn acoustic devices, or other similar personal audio devices, during the activity, such as, but not limited to, sitting, walking, jogging, running, or any other movement.

One or more audio events are captured, at step 104 from the environment. The one or more audio events may include audio events that occur within a specific time frame in the environment. Examples of the audio events include speech events such as screaming or calling, as well as non-voice sounds like car horns, etc. In an embodiment, each captured audio event is classified as noise or significant audio based on the environment and significance level of the audio and in presence of more than one significant audio, priority is given to the significant audio based on the direction of the audio with respect to the head direction of the use.

A direction of the environmental audio event producing source is determined, at step 106. In an example embodiment, the direction of the audio event producing source may provide valuable information about origin of the audio, allowing the user to accurately locate the source of the audio event. This may be important in various situations like audio source localization in floods, fire incident, robbery, enemy destruction, thief catching etc., where it is necessary to precisely identify the location of the audio event.

A virtual sound source is localized for generating a spatial binaural audio alert with respect to current head direction of the user and provide the alert on the personal audio device, at step 108. In an embodiment, the alert may include a gamma binaural audio alert. In an embodiment, the alert may include a multimodal alert when the user is equipped with a wearable device which includes, at least but not limited to, a wristband, wristwatch, augmented reality glasses, smart glasses, ring, necklace, or any other electronic device that is worn as an accessory, implanted in the user's body, embedded in clothing, or tattooed on the skin and provided to the user via two dimensional or three dimensional simulations.

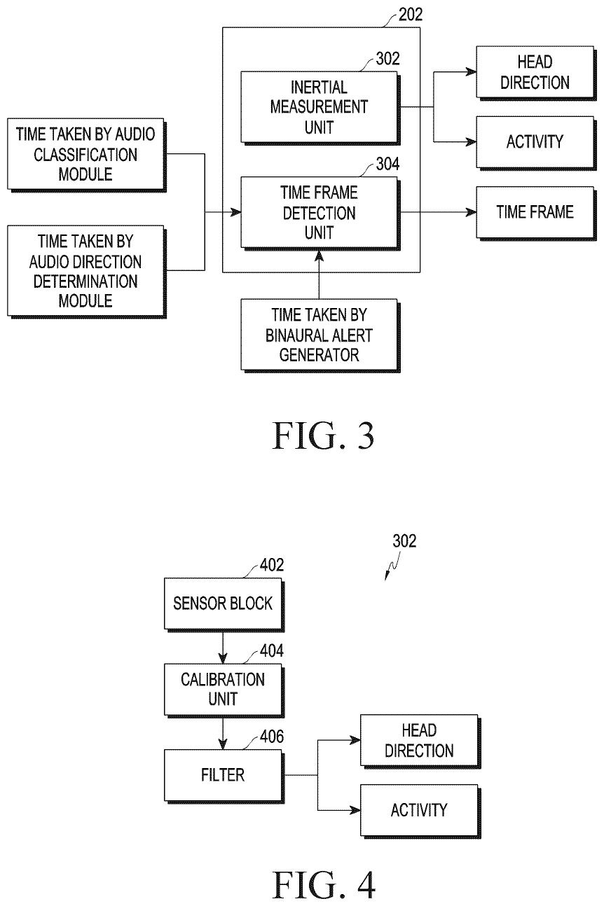

FIG. 2 is a block diagram illustrating an example configuration for providing the spatial binaural environmental audio alert on the personal audio device according to various embodiments. The system (200) may be implemented in an electronic device. The electronic device may an electronic device wiredly or wirelessly connected to the personal audio device and providing audio data to the personal audio device. In some embodiment, the electronic device may be the personal electronic device. The electronic device may comprise memory storing instructions, and at least one processor configured to, when executing the instructions, cause the electronic device to perform functions of the blocks of the system (200). The system (200) comprises a processing module (202) (e.g., including a processor including various processing circuitry), which is configured for determining head direction and activity of the user in the environment in a time frame, which is explained in greater detail below with reference to FIG. 3. In an embodiment, the processing module (202) determines the head direction and the activity while the user is on a call or listening to audio or music using the personal audio device. The processor of the processing module 202 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Referring to FIG. 3, a block diagram of the processing module (202) is illustrated according to various embodiments. In order to determine the head direction and the activity, the processing module (202) comprises an inertial measurement unit (302). The inertial measurement unit (302) may include various circuitry and/or executable program instructions and determines the head direction and the activity of the user using sensor data collected from a plurality of sensors, which is explained in greater detail below with reference to FIG. 4.

As depicted in FIG. 4, the inertial measurement unit (302) may include a sensor block (402), including at least one sensor, which is configured for providing sensor data from a reference point that works as a reference for the sensor data. In an embodiment, the sensor block (402) includes the plurality of sensors such as, but not limited to, a three-axis accelerometer, a three-axis gyroscope, and a three-axis magnetometer.

The inertial measurement unit (302) further comprises a calibration unit including various circuitry (404), which is configured for monitoring difference between input and output sensor data of each sensor and adjusting the output sensor data to align with the input. The inertial measurement unit (302) further comprises a filter (406) for removing noise and smoothing the calibrated sensor data to provide an accurate head direction and the activity of the user. In an embodiment, the inertial measurement unit (302) determines the head direction and the activity with respect to magnetic north which is the reference point. In an example embodiment, if the head direction is towards right of the running direction and the reference point, then degree of deviation of the head from the running direction (02) may be computed using equation given below:

$${θ}_{2} = θ - {θ}_{1}$$

Wherein, θ is user head deviation from the magnetic north and θ₁ is degree of deviation of direction of running from the reference magnetic north.

In an embodiment, if the head direction is towards left of the running direction and the reference point, then degree of deviation of the head from the running direction (θ₂) may be computed using equation given below:

$${θ}_{2} = - ( {θ}_{1} - ( - θ ) )$$

In an embodiment, if the head direction is towards left of the running direction and right of the reference point, then degree of deviation of the head from the running direction (θ₂) may be computed using equation given below:

$${θ}_{2} = - ( {θ}_{1} - θ )$$

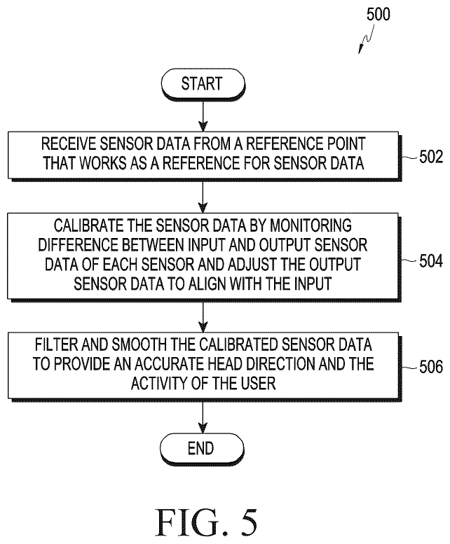

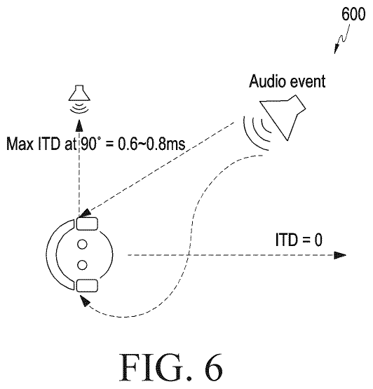

FIG. 5, is a flowchart illustrating an example method of working of the inertial measurement unit according to various embodiments. The method includes receiving sensor data from a reference point, at step 502. In an embodiment, the sensor data is received from the sensor block which includes the plurality of sensors such as, but not limited to, a three-axis accelerometer, a three-axis gyroscope, and a three-axis magnetometer. The sensor data is calibrated, at step 504. The sensor data is calibrated by monitoring difference between input and output sensor data of each sensor and adjusting the output sensor data to align with the input. The calibrated sensor data is filtered and smoothed, at step 506, to provide an accurate head direction and the activity of the user.

The processing module (202) further comprises a time frame detection unit (e.g., comprising various circuitry and/or executable program instructions) (304) for determining time frame based on initial time frame or computation time of each module including the maximum interaural time delay (ITD), time taken by the audio classification module (204), time taken by the audio direction determination module (206), and time taken by the binaural alert generator (208). ITD refers to difference in time between the arrival of an audio wave to the two ears, as illustrated in FIG. 6. As depicted, the ITD is 0.6˜0.8 ms, which is the maximum at 90 degrees, and the ITD is zero at 0 degrees. The ITD is critical in localizing a virtual sound source and computing horizontal angle of the sound source relative to the head. Further, a time window between 20 to 30 ms for analyzing spectral characteristics may be used. This time window may provide a way to analyze the frequency content of the audio within relatively short intervals and facilitate the extraction of useful spectral features. Additionally, to ensure that the temporal characteristics of individual audio are captured, the time window may be advanced every 5 to 10 ms. This enables the analysis of the fine-grained temporal changes in the audio waveforms and help to track the dynamic evolution of audio over time.

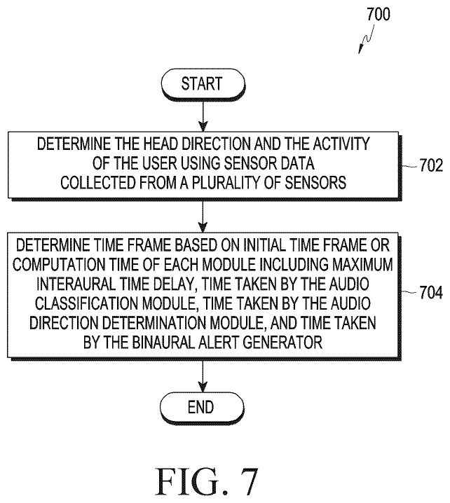

FIG. 7, is a flowchart illustrating an example method of working of the processing module according to various embodiments. The method includes determining the head direction and the activity of the user, at step 702, using sensor data collected from a plurality of sensors. A time frame is determined, at step 704, based on initial time frame or computation time of each module including maximum interaural time delay (ITD), time taken by the audio classification module (204), time taken by the audio direction determination module (206), and time taken by the binaural alert generator (208).

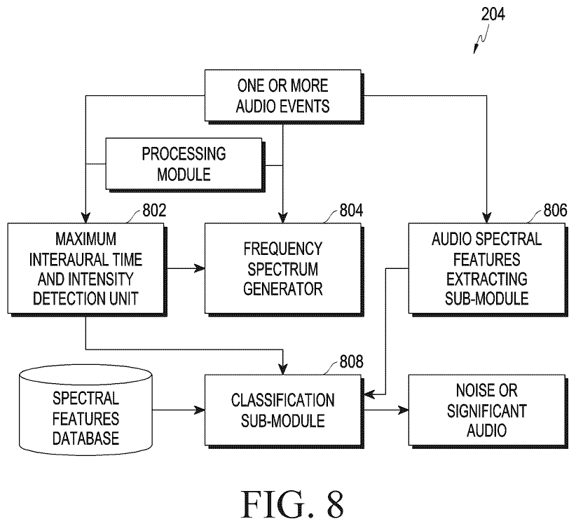

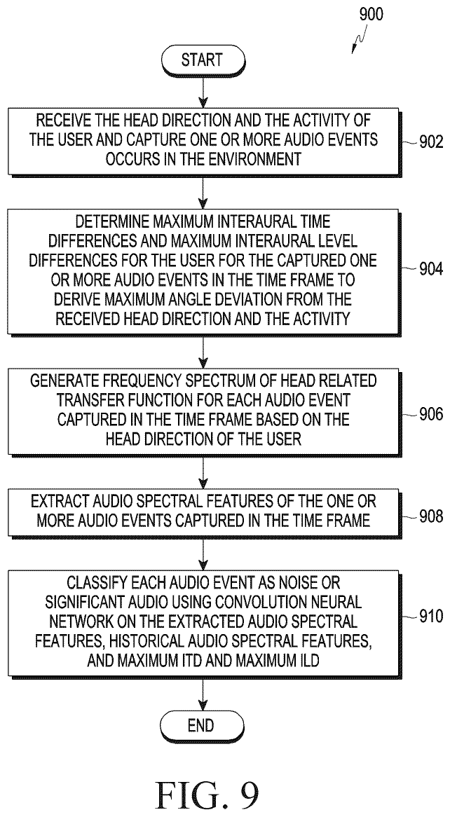

The system (200) further comprises an audio classification module (204). The classification module (204) is configured for capturing one or more audio events occurs in the environment in the time frame. The classification module (204) is further configured to classify each audio event as noise or significant audio, as illustrated in greater detail below with reference to FIG. 8 and FIG. 9.

FIG. 8 is a block diagram illustrating an example configuration of the audio classification module (204) according to various embodiments.

As depicted, the audio classification module (204) comprises a maximum interaural time and intensity detection unit (802), a frequency spectrum generator (804), and an audio spectral features extracting sub-module (806) for capturing one or more audio events and classifying each captured audio event as noise or significant audio, each of the classification module 204, the maximum interaural time and intensity detection unit 802, frequency spectrum generator 804 and spectral features extracting module 806 may include various circuitry and/or executable program instructions.

In an embodiment, the maximum interaural time and intensity detection unit (802) is configured for determining maximum interaural time differences (ITD) and maximum interaural level differences (ILD) for the user for the captured one or more audio events in the time frame. The ILD refers to the difference in the levels of audio signals arriving at both ears. In simpler terms, energy level of an audio wave arriving at an ear is compared with that of arriving at the other ear. Significantly louder audios are perceived as originating from the side that receives them. The maximum interaural time difference (ITD) is determined by taking maximum value of the maximum ITD from previous time frames and the ITD from each of the one or more audio events occurring in the environment. Further, the personalized maximum ITD may be defined mathematically as:

Personalized Max ITD=max(Max ITD,S₁,S₂,S₃,S₄)

Wherein, S₁ is the ITD from environment audio event 1, S₂ is the ITD from environment audio event 2, S₃ is the ITD from environment audio event 3, and S₄ is the ITD from environment audio event 4.

The maximum ILD is determined based on maximum level of the one or more audio events, e.g. Max IID=max(L₁, L₂, L₃, L₄) Wherein, L₁, L₂, L₃, and L₄ are levels (dB) of the environment audio events 1, 2, 3 & 4 respectively.

It should be noted that the ITD and the ILD are determined to derive maximum angle deviation from the head direction and the activity determined by the processing module (202). In an example embodiment, if dirₛ₂=dir(MAX_{ITD}), the head direction is checked to determine if the head is able to move in left of right direction.

In an embodiment, the frequency spectrum generator (804) is configured for generating frequency spectrum of head related transfer function (HRTF) for each audio event captured in the time frame based on the head direction of the user. It should be noted that the HRTF refers to a phenomenon that describes how ear receives audio from the environment audio events and hence plays a critical role in audio source localization and spatial hearing. Further, the HRTF may be personalized and stored in a HRTF database for each user to achieve more accurate and immersive binaural audio experiences.

The audio spectral features extracting sub-module (806) is configured for extracting audio spectral features of the one or more audio events captured in the time frame. In an embodiment, the audio spectral features extracting sub-module (806) includes a discrete fourier transform (DFT), a Mel filter bank, and a Mel frequency cepstral coefficients (MFCC). The DFT converts time-domain audio signal into frequency-domain representation or complex-valued frequency spectrum that contains information about the strength and phase of each frequency component in the audio signal. The Mel filter bank is a series of triangular band-pass filters used in audio signal processing to extract Mel-frequency spectrograms. The Mel filter bank is configured to receive the frequency spectrum obtained from the DFT and generate a more compact representation of the spectrum by preserving essential frequency features. The MFCC is a feature extraction technique which is based on the idea that the human ear perceives audio differently depending on their frequency content and extracts audio spectral features relevant to human speech perception.

The classification sub-module (e.g., including various circuitry and/or executable program instructions) (808) is configured for classifying each audio event as noise or significant audio. In an embodiment, the classification sub-module (808) receives extracted audio spectral features from the audio spectral features extracting sub-module (806), historical audio spectral features from spectral features database, and maximum ITD and maximum ILD from the maximum interaural time and intensity detection sub-module (802) and uses a convolution neural network on the received inputs to classify the audio event. In an example embodiment, when there are one or more audio events in an environment, including but not limited to children playing, cars beeping, people gossiping and birds chirping, occurring in a time frame of 5-10 seconds, the audio classification module (204) captures each audio event and subsequently, subjects all captured audio events to a classification process, where it classifies the captured audio event containing a car beep as significant audio, and the other audio events as noise. In an embodiment, each audio event is classified based on the environment and significance level of the audio and in presence of more than one significant audio, priority is given to the significant audio based on the direction of the audio with respect to the head direction of the user.

FIG. 9 is a flowchart illustrating an example method of working of the audio classification module according to various embodiments. The head direction and the activity of the user are received from the processing module (202) and one or more audio events occurs in the environment are captured, at step 902.

Maximum interaural time differences (ITD) and maximum interaural level differences (ILD) are determined for the user for the captured one or more audio events in the time frame to derive maximum angle deviation from the received head direction and the activity, at step 904. In an embodiment, the maximum ITD is determined based on maximum of maximum ITD from previous time frames and ITD from each of the one or more audio events occurred in the environment and maximum ILD is determined based on maximum level of the one or more audio events.

Frequency spectrum of head related transfer function (HRTF) is generated, at step 906, for each audio event captured in the time frame based on the head direction of the user. Audio spectral features of the one or more audio events captured in the time frame are extracted, at step 908. In an embodiment, the audio spectral features of the one or more audio events are extracted using discrete fourier transform, a Mel filter bank, and a MFCC.

Each audio event is classified, at step 910, as noise or significant audio. In an embodiment, each audio event is classified using convolution neural network on the extracted audio spectral features from the audio spectral features extracting sub-module (806), historical audio spectral features from spectral features database, and maximum ITD and maximum ILD from the maximum interaural time and intensity detection sub-module (802).

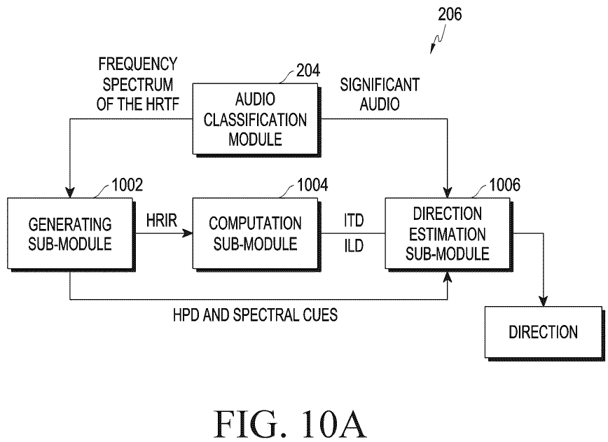

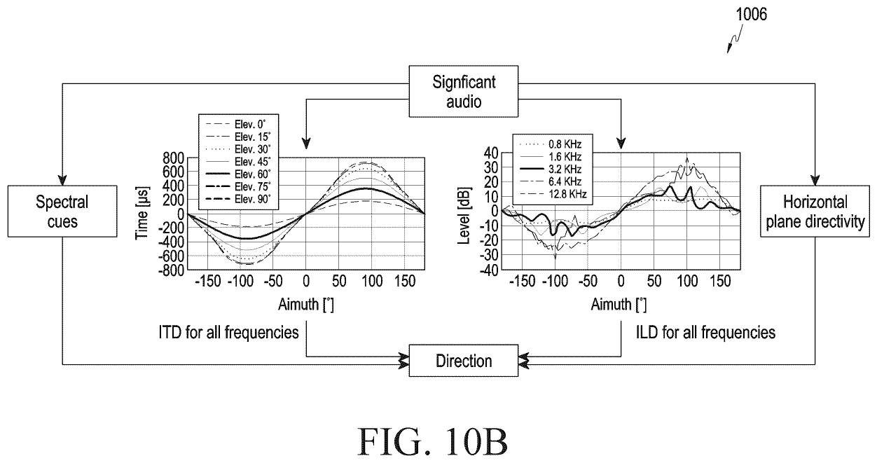

The system (200) further comprises an audio direction determination module (e.g., including various circuitry and/or executable program instructions) (206). The audio direction determination module (206) is configured for determining direction of environmental audio event producing source, as explained in greater detail below with reference to FIG. 10A and FIG. 10B.

FIG. 10A is a block diagram illustrating an example configuration of the audio direction determination module (206) according to various embodiments.

As depicted, the audio direction determination module (206) comprises a generating sub-module (1002), a computation sub-module (1004), and a direction estimation sub-module (1006) for determining direction of environmental audio event producing source, each of which include various circuitry and/or executable program instructions. In an embodiment, the generating sub-module (1002) is configured for receiving frequency spectrum of the HRTF for the one or more audio events from the audio classification module (204) and generating horizontal plane directivity (HPD), head related impulse response (HRIR) and pinna related transfer function (PRTF) from the received HRTF frequency spectrum. The HPD refers to directional sound intensity of the audio source with respect to the horizontal plane of the user. The HRIR is a specific type of the HRTF that represents the impulse response of the head, torso, and outer ear to the audio wave. In other words, it is the time and frequency response of the audio entering the ear canal and reaching the inner ear. The PRTF is another type of HRTF that is concerned only with the effect of outer ear (pinna) on the audio waves. The PRTF is used to understand the effect of the pinna on the audio waves, which helps to localize the audio source and provides cues for the perception of elevation. The computation sub-module (1004) is configured for computing interaural time difference (ITD) and interaural level difference (ILD) for left and right ears of the user using the HRIR. The direction estimation sub-module (1006) is configured for determining direction of the environmental audio event producing source based on the significant audio received from the audio classification module (204), the ITD and the ILD, the horizontal plane directivity, and spectral cues from the PRTF, as depicted in FIG. 10B. In an example embodiment, azimuth range is −180 degrees to 180 degrees, elevation range is −90° to 90°, the ITD Range is −0.8 ms to 0.8 ms, and ILD Range is generally in dBs which varies on the basis of wide bands and narrow bands.

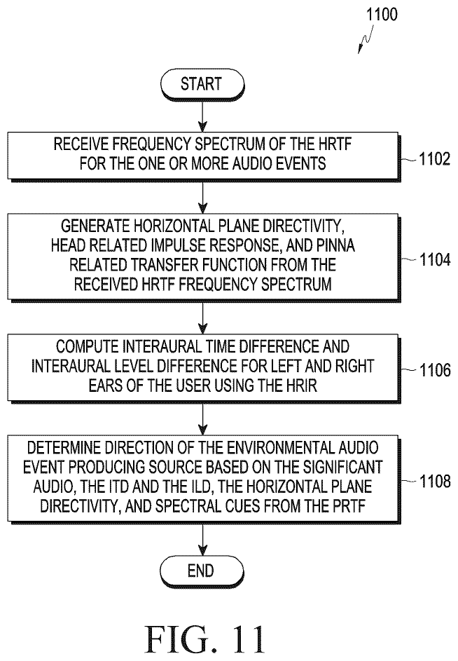

FIG. 11 is a flowchart illustrating an example method of working of the audio direction determination module according to various embodiments. Frequency spectrum of the HRTF is received, at step 1102, for the one or more audio events from the audio classification module (204). Horizontal plane directivity (HPD), head related impulse response (HRIR) and pinna related transfer function (PRTF) are generated, at step 1104, from the received HRTF frequency spectrum.

Interaural time difference (ITD) and interaural level difference (ILD) for left and right ears of the user are computed using the HRIR, at step 1106. Direction of the environmental audio event producing source is determined, at step 1108, based on the significant audio received from the audio classification module (204), the ITD and the ILD, the horizontal plane directivity, and spectral cues from the PRTF.

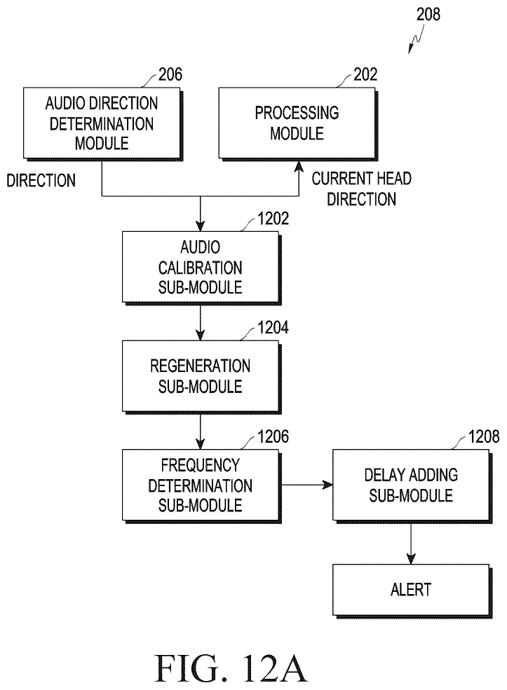

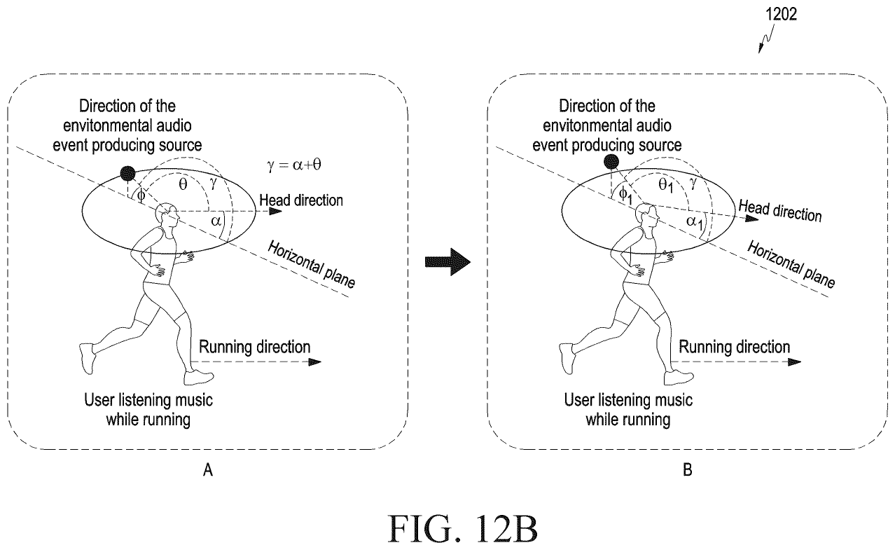

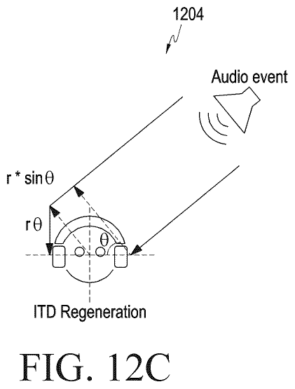

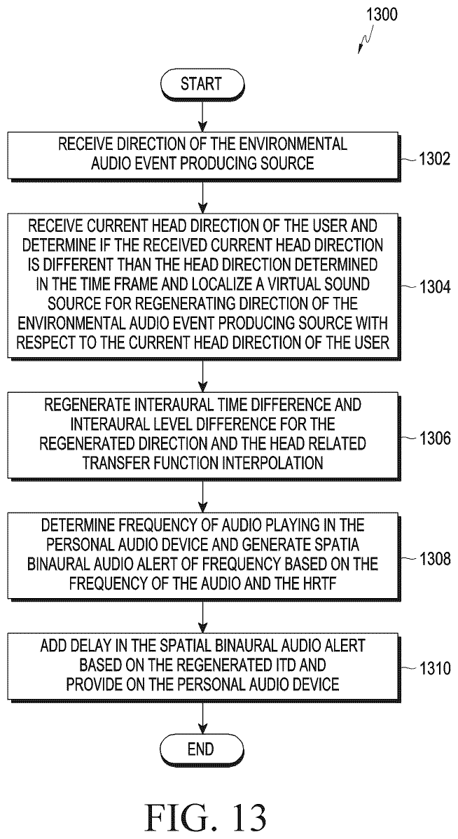

The system (200) further comprises a binaural alert generator (e.g., including various circuitry and/or executable program instructions) (208). The binaural alert generator (208) is configured for localizing a virtual sound source for generating a spatial binaural audio alert with respect to current head direction of the user and providing the alert on the personal audio device, as explained in greater detail below with reference to FIG. 12A, FIG. 12B, FIG. 12C, and FIG. 13.

FIG. 12A is a block diagram illustrating an example configuration of the binaural alert generator (208) according to various embodiments.

The binaural alert generator (208) comprises an audio calibration sub-module (1202), a regeneration sub-module (1204), a frequency determination sub-module (1206), and a delay adding sub-module (1208) for localizing a virtual sound source for generating a spatial binaural audio alert with respect to current head direction of the user and providing the alert, each of which include various circuitry and/or executable program instructions.

The audio calibration sub-module (1202) is configured for receiving direction of the environmental audio event producing source from the audio direction determination module (206) and current head direction of the user from the processing module (202) and determining if the received current head direction is different than the head direction determined in the time frame and localizing a virtual sound source for regenerating direction of the environmental audio event producing source with respect to the current head direction of the user, which is explained in greater detail below with reference to FIG. 12B.

Referring to “A” of FIG. 12B, in which the user is performing a running activity while listening to music, θ represents the azimuth angle of the environmental audio event producing source from the user head, a represents the direction of the head from the reference point (median plane), ϕ represents elevation angle of the environmental audio event producing source from the user head and γ represents the direction of the environmental audio event producing source from the reference point (median plane). Similarly, θ₁ represents the azimuth angle, α₁ represents the direction of the head, and ϕ₁ represents new elevation angle for the user depicted in “B”. The audio calibration sub-module (1202) receives the head direction and determines if the received current head direction (a₁) is different than the head direction (a) determined in the time frame.

### If (α₁ !=α),

Then, the direction of the environmental audio event producing source from the reference point is γ=α+θ and the new direction di of the environmental audio event producing source from the new head direction (α₁) may be calculated as

$$\begin{matrix}{θ}_{1} = - {a}_{1} , where = a + θ \\ {θ}_{1} = θ + ( a - {a}_{1} )\end{matrix}$$

For left median plane (left ear), −180≤θ, θ₁≤0
For right median plane (right ear), 0≤θ, θ₁≤180
Elevation angle, −90≤ϕ, ϕ₁≤90 and Elevation Shift=(ϕ−ϕ₁)

The regeneration sub-module (1204) is configured for regenerating interaural time difference (ITD) and interaural level difference (ILD) for the regenerated direction and the head related transfer function (HRTF) interpolation, as illustrated in FIG. 12C. For the new direction of the environmental audio event producing source e.g. ϕ₁=θ+(α−α₁), the new ITD may be

$$New ITD = r * ( {θ}_{1} + sin {θ}_{1} )$$

Wherein, r is the radius of the head

The frequency determination sub-module (1206) is configured for determining frequency of audio playing in the personal audio device and generating spatial binaural audio alert of frequency based on the frequency of the audio and the HRTF. In an embodiment, if the user is listening to audio at a frequency of F_{music}, then the binaural carrier frequency of F_{binaural} that needs to be generated should be higher than F_{music} e.g., F_{binaural}>F_{music}. For example, if F_{music} is 400 Hz then F_{binaural} of 440 Hz is required to be generated.

The delay adding sub-module (1208) is configured for adding delay in the spatial binaural audio alert based on the regenerated ITD and providing on the personal audio device. In an exemplary embodiment, if F_{binaural} is set to 440 Hz, then Lear_{Binaural} is required to be 440 Hz, and Rear_{Binaural} is required to be 480 Hz, in order to create a gamma frequency (f=40 Hz). It should be noted that the binaural alert with frequencies of 440 Hz and 480 Hz is achieved using the NewITD. In another case, where the user is equipped with a wearable device which includes, at least but not limited to, a wristband, wristwatch, augmented reality glasses, smart glasses, ring, necklace, or any other electronic device that is worn as an accessory, implanted in the user's body, embedded in clothing, or tattooed on the skin, a multimodal alert may be provided to the user via two dimensional or three dimensional simulations.

FIG. 13 is a flowchart illustrating an example method of working of the binaural alert generator is depicted. A direction of the environmental audio event producing source is received, at step 1302, from the audio direction determination module (206). Current head direction of the user is received from the processing module (202) and determination if the received current head direction is different than the head direction determined in the time frame is performed and a virtual sound source is localized for regenerating direction of the environmental audio event producing source with respect to the current head direction of the user, at step 1304. Interaural time difference (ITD) and interaural level difference (ILD) for the regenerated direction and the head related transfer function (HRTF) interpolation are regenerated, at step 1306. Frequency of audio playing in the personal audio device is determined and spatial binaural audio alert of frequency based on the frequency of the audio and the HRTF is generated, at step 1308. A delay is added in the spatial binaural audio alert based on the regenerated ITD and provided on the personal audio device, at step 1310.

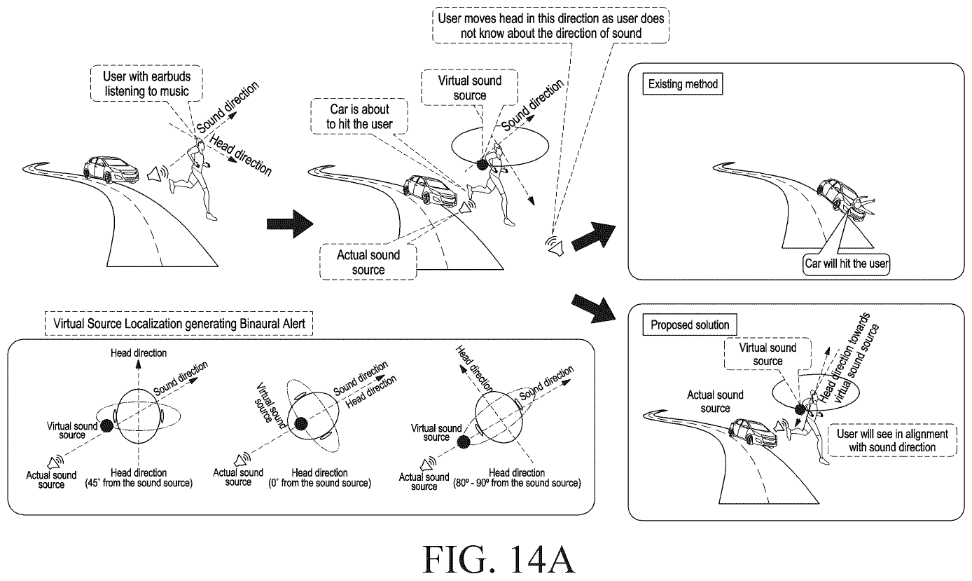

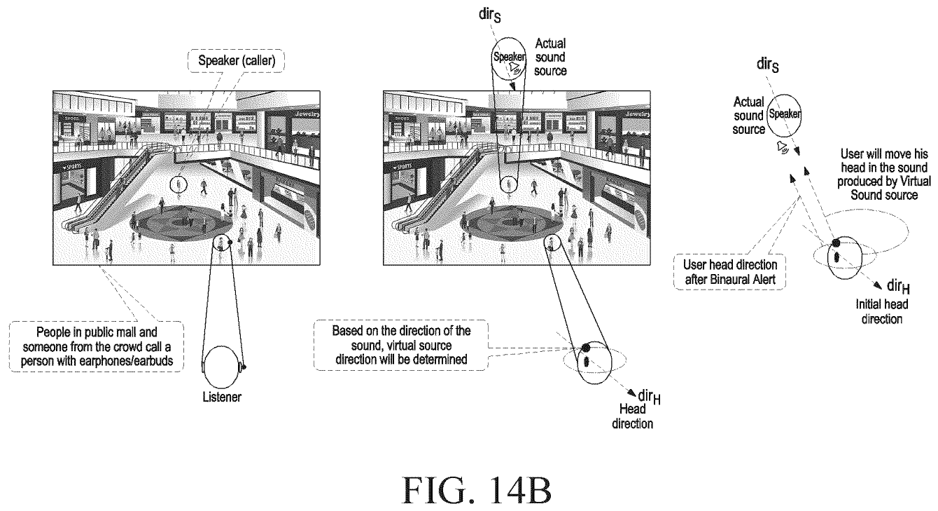

\FIG. 14A is a diagram illustrating a first use case of providing spatial binaural environmental audio alert on the personal audio according to various embodiments. As depicted, the user is listening to music on earbuds while a car is approaching towards him. In the existing method, although the user is able to listen to the car horn but unable to determine the direction from where it is coming, and met with an accident. To avoid this situation, according to various embodiments, localizes the virtual sound source with respect to the head direction while the user enjoying the music and enables the user to see in the direction of the alert and saves the user from the accident.

FIG. 14B is a second use case of providing spatial binaural environmental audio alert on the personal audio device according to various embodiments. As depicted, the user is in a mall enjoying audio using the earphones when someone from the crowd calls out to the user. In this case, various embodiments of the disclosure determine the direction of the virtual sound source based on the direction of the sound, and provides a spatial binaural audio alert in relation to the user current head direction. This allows the user to move the head towards the source of the sound and better locate the person calling out to the user in the crowd.

Additionally the present disclosure may be implemented in a scenario where a fire incident has occurred at a house and people are trapped at the backside. A rescue team equipped with augmented reality glasses and earphones is present on the site. With the implementation of the present disclosure, the sound direction localization of the trapped individual is determined and utilized along with the eye tracking to provide path to the trapped individual in order to rescue them safely.

It has thus been seen that the system and method for providing spatial binaural environmental audio alert on a personal audio device according to the present disclosure achieve various non-limiting example aspects highlighted earlier. Such a system and method can in any case undergo numerous modifications and variants, all of which are covered by the same innovative concept, moreover, all of the details can be replaced by technically equivalent elements. It will be understood that any of the embodiment(s) described herein may be used in conjunction with any other embodiment(s) described herein.

What is claimed is:

1. A method for providing an environmental audio alert on a personal audio device, the method comprising:
determining head direction of a user in an environment in a time frame;
detecting an audio event occurring in the environment in the time frame;
determining a direction of a source of the detected audio event; and
localizing a sound source with respect to the determined head direction of the user for generating a spatial binaural audio alert and providing the generated spatial binaural audio alert on the personal audio device.

2. The method of claim 1, wherein the head direction is determined while the user is on a call or listening to music using the personal audio device, the personal audio device including around-the-ear, over-the-ear and in-ear headsets, headphones, earphones, earbuds, hearing aids, audio eyeglasses, head-worn audio devices, shoulder- or body-worn acoustic devices, during an activity of the user, the activity including, sitting, walking, jogging, running, or any movement.

3. The method of claim 1, wherein determining the head direction of the user in the time frame comprises:
determining the head direction of the user using sensor data collected from a plurality of sensors; and
determining the time frame based on initial time frame or computation time including maximum interaural time delay (ITD), time taken by an audio classification module, time taken by an audio direction determination module, and time taken by a binaural alert generator.

4. The method of claim 3, wherein determining the head direction comprises:
receiving sensor data from a reference point as a reference for the sensor data, wherein the sensor data is received from a sensor block including the plurality of sensors, the sensor block including at least one of a three-axis accelerometer, a three-axis gyroscope, and a three-axis magnetometer;
calibrating the sensor data by monitoring difference between input and output sensor data of each sensor and adjusting the output sensor data to align with the input; and
filtering and smoothing the calibrated sensor data to provide the head direction of the user.

5. The method of claim 1, further comprising:
determining maximum interaural time differences (ITD) and maximum interaural level differences (ILD for the user for the detected audio event in the time frame to derive maximum angle deviation from the head direction and an activity of the user, wherein the maximum ITD is determined based on maximum of maximum ITD from previous time frames and ITD from the detected audio event and maximum ILD is determined based on maximum level of the detected audio event;
generating a frequency spectrum of head related transfer function (HRTF) for the detected audio event based on the head direction of the user;
extracting audio spectral features of the detected audio event using at least one of a discrete fourier transform, a Mel filter bank, and Mel frequency cepstral coefficients (MFCC); and
classifying the audio event as noise or significant audio using a convolution neural network on the extracted audio spectral features, historical audio spectral features from a spectral features database, and maximum ITD and maximum ILD.

6. The method of claim 5, wherein the audio event is classified based on the environment and significance level of audio and in presence of more than one significant audio, and a priority is given to the significant audio based on the direction of the audio with respect to the head direction of the user.

7. The method of claim 1, wherein determining the direction of the source of the detected audio event comprises:
identifying frequency spectrum of a head related transfer function (HRTF) for the audio event;
generating horizontal plane directivity (HPD), head related impulse response (HRIR) and pinna related transfer function (PRTF) from the HRTF frequency spectrum;
computing interaural time difference (ITD) and interaural level difference (ILD) for left and right ears of the user using the HRIR; and
determining a direction of the environmental audio event producing source based on significant audio, the ITD and the ILD, the horizontal plane directivity, and spectral cues from the PRTF.

8. The method of claim 1, wherein generating the spatial binaural audio alert comprises:
localizing a virtual sound source for regenerating the direction of the source of the audio event with respect to the head direction of the user;
regenerating interaural time difference (ITD) and interaural level difference (ILD) for the regenerated direction and head related transfer function (HRTF) interpolation;
determining a frequency of audio playing in the personal audio device and generating the spatial binaural audio alert based on the frequency of the audio and the HRTF; and
adding a delay in the spatial binaural audio alert based on the regenerated ITD.

9. The method of claim 1, wherein the alert includes a gamma binaural audio alert or the alert includes a multimodal alert based on the user being equipped with a wearable device which includes, at least one of, a wristband, wristwatch, augmented reality glasses, smart glasses, ring, necklace, an accessory device, implanted in the user's body, embedded in clothing, or tattooed on the skin and provided to the user via two dimensional or three dimensional simulations.

10. An electronic device for providing an environmental audio alert on a personal audio device, the electronic device comprising:
memory storing instructions; and
at least one processor configured to, when executing the instructions, cause the electronic device to perform operations comprising:
determining head direction of a user in an environment in a time frame;
detecting an audio event occurring in the environment in the time frame;
determining a direction of a source of the detected audio event; and
localizing a sound source with respect to the determined head direction of the user to generate a spatial binaural audio alert and providing the generated spatial binaural audio alert on the personal audio device.

11. The electronic device of claim 10, wherein the head direction is determined while the user is on a call or listening to music using the personal audio device, the personal audio device including at least one of, around-the-ear, over-the-ear and in-ear headsets, headphones, earphones, earbuds, hearing aids, audio eyeglasses, head-worn audio devices, shoulder- or body-worn acoustic devices, during an activity of the user, to the activity including at least one of, sitting, walking, jogging, running, or movement.

12. The electronic device of claim 10, wherein determining the head direction of the user in the time frame comprises:
determining the head direction of the user using sensor data collected from a plurality of sensors; and
determining time frame based on initial time frame or computation time of each module including the maximum interaural time delay (ITD), time taken by the audio classification module, time taken by the audio direction determination module, and time taken by the binaural alert generator.

13. The electronic device of claim 12, wherein determining the head direction comprises:
receiving the sensor data from a reference point including a reference for the sensor data, wherein the sensor block includes a plurality of sensors including at least one of, a three-axis accelerometer, a three-axis gyroscope, and a three-axis magnetometer;
calibrating the sensor data by monitoring difference between input and output sensor data of each sensor and adjusting the output sensor data to align with the input; and
filtering and smoothing the calibrated sensor data to provide the head direction of the user.

14. The electronic device of claim 10, wherein the operations further comprise:
determining maximum interaural time differences (ITD) and maximum interaural level differences (ILD) for the user for the detected audio event in the time frame to derive maximum angle deviation from the head direction and an activity of the user, wherein the maximum ITD for the user is determined based on maximum of maximum ITD from previous time frames and ITD from the detected audio event and maximum ILD is determined based on maximum level of the detected audio event;
generating a frequency spectrum of head related transfer function (HRTF) for the detected audio event based on the head direction of the user;
extracting audio spectral features of the detected audio event using a discrete fourier transform, a Mel filter bank, and Mel frequency cepstral coefficients (MFCC); and
classifying the audio event as noise or significant audio using a convolution neural network on the extracted audio spectral features from the audio spectral features extracting sub-module, historical audio spectral features from spectral features database, and maximum ITD and maximum ILD.

15. The electronic device of claim 14, wherein the audio event is classified based on the environment and significance level of audio and in presence of more than one significant audio, wherein a priority is given to the significant audio based on the direction of the audio with respect to the head direction of the user.

16. The electronic device of claim 10, wherein determining the direction of the source of the detected audio event comprises:
identifying frequency spectrum of a head related transfer function (HRTF) for the audio event;
generating horizontal plane directivity (HPD), head related impulse response (HRIR) and pinna related transfer function (PRTF) from the HRTF frequency spectrum;
computing interaural time difference (ITD) and interaural level difference (ILD) for left and right ears of the user using the HRIR; and
determining a direction of the environmental audio event producing source based on significant audio, the ITD and the ILD, the horizontal plane directivity, and spectral cues from the PRTF.

17. The electronic device of claim 10, wherein generating the spatial binaural audio alert comprises:
localizing a virtual sound source to regenerate the direction of the source of the audio event with respect to the head direction of the user;
regenerating an interaural time difference (ITD) and interaural level difference (ILD) for the regenerated direction and head related transfer function (HRTF) interpolation,
determining a frequency of audio playing in the personal audio device and to generate the spatial binaural audio alert based on the frequency of the audio and the HRTF; and
adding a delay in the spatial binaural audio alert based on the regenerated ITD.

18. The electronic device of claim 10, wherein the alert includes a gamma binaural audio alert or the alert includes a multimodal alert based on the user being equipped with a wearable device including at least one of, a wristband, wristwatch, augmented reality glasses, smart glasses, ring, necklace, or an accessory device, implanted in the user's body, embedded in clothing, or tattooed on the skin and provided to the user via two dimensional or three dimensional simulations.

19. A non-transitory computer readable storage medium storing instructions which, when executed by at least one processor of an electronic device, cause the electronic device to perform operations, the operations comprising:
determining head direction of a user in an environment in a time frame;
detecting an audio event occurring in the environment in the time frame;
determining a direction of a source of the detected audio event; and
localizing a sound source with respect to the determined head direction of the user for generating a spatial binaural audio alert and providing the generated spatial binaural audio alert on the personal audio device.

20. The non-transitory computer readable storage medium of claim 19, wherein the head direction is determined while the user is on a call or listening to music using the personal audio device, the personal audio device including around-the-ear, over-the-ear and in-ear headsets, headphones, earphones, earbuds, hearing aids, audio eyeglasses, head-worn audio devices, shoulder- or body-worn acoustic devices, during an activity of the user, the activity including, sitting, walking, jogging, running, or any movement.
